(19) United States
(12) Patent Application Publication
(10) Pub. No.: US 2014/0049649 A1
(43) Pub. Date: Feb. 20, 2014

(54) PORTABLE DEVICE AND SIGNAL CONVERTING METHOD THEREOF

(71) Applicant: HON HAI PRECISION INDUSTRY CO., LTD., New Taipei (TW)

(72) Inventor: CHUN-YIN CHANG, New Taipei (TW)

(73) Assignee: HON HAI PRECISION INDUSTRY CO., LTD., New Taipei (TW)

(21) Appl. No.: 13/956,429

(22) Filed: Aug. 1, 2013

(30) Foreign Application Priority Data
Aug. 15, 2012 (TW) 101129580

(51) Int. Cl. H04N 17/00

(52) U.S. Cl. CPC H04N 17/00
USPC 348/181

(57) ABSTRACT

A portable device for communicating with an electronic device comprises a first communicating module, a processing module, and a converting module. The first communicating module intercommunicates data between the portable device and the electronic device. When the processing unit generates the instruction data in a first format, the converting module converts the instruction data from the first format to a second format, the communicating module transmits the coveted instruction data to the electronic device, so as to control the electronic device to generate feedback data which is in the second format; the communicating module further receives the feedback data in the second format from the electronic device, the converting module converts the feedback data from the second format to the first format which can be processed by the processing module.

### BACKGROUND

1. Technical Field

The present disclosure relates to a portable device for testing functions of an electronic device.

2. Description of Related Art

Electronic devices, such as TVs or DVD players need to be tested before they are distributed to retailers. However, a tester device may not be able to directly communicate/connect with an electronic device. Therefore, a patching board is connected between the tester device and the electronic device to convert a format of the data of one device into another format which can be support by the other device or vice versa. However, it is inconvenient for an operator to carry the tester device and the patching board to test the electronic device.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the portable device and signal converting method thereof. Moreover, in the drawings, like reference numerals designate corresponding parts throughout the several views.

FIG. 1 is a schematic diagram of a portable device and an electronic device in accordance with an embodiment.

FIG. 2 is a block diagram of the portable device in accordance with an embodiment.

FIG. 3 is a block diagram of a processing module of the portable device of FIG. 1.

FIG. 4 is a flowchart of a signal converting method in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

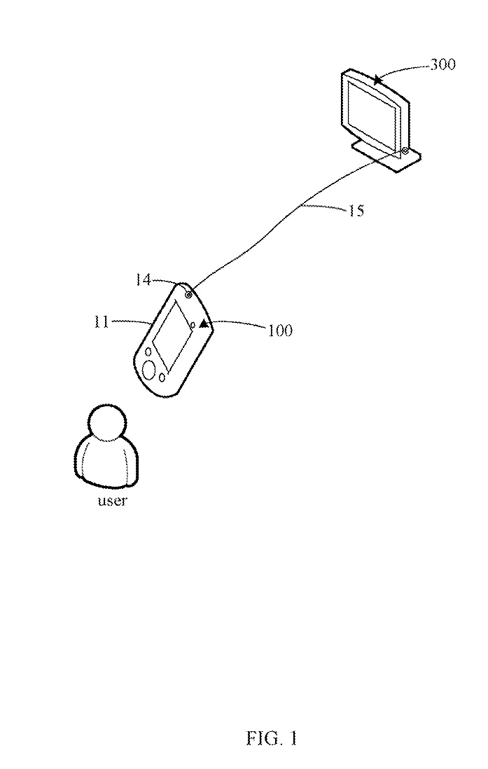

FIG. 1 shows a portable device 100 and an electronic device 300 of an embodiment. The portable device 100 and the electronic device 300 directly intercommunicate with each other. The portable device 100 is capable of converting instruction data from a first format to a second format which can be supported by the electronic device 300. The electronic device 300 further sends feedback data in the second format to the portable device 100. In the embodiment, the portable device 100 is a mobile phone; the electronic device 300 can be a television, computer, or to-be-tested machine, for example; the first format can be low-voltage differential signaling (LVDS) format, and the second format can be video graphics array (VGA) format.

The portable device 100 connects with electronic device 300 with a data cable 15, and includes a casing 11, and an interface 14. The casing 11 is substantially rectangular and is used for receiving and protecting electronic parts of the portable device 100, such as, printed circuit boards. The interface 14 is located on the casing 14 and is used for connecting with external device. In the embodiment, the interface 15 is a headphone interface. In other embodiments, the interface 15 can be a USB interface, a VGA interface, or a HDMI interface, for example. The data cable 15 connects between the interface 14 and the electronic device 300 for establishing a connection between the portable device 100 and the electronic device 300. In other embodiments, the portable device 100 can connect with the electronic device 300 wirelessly.

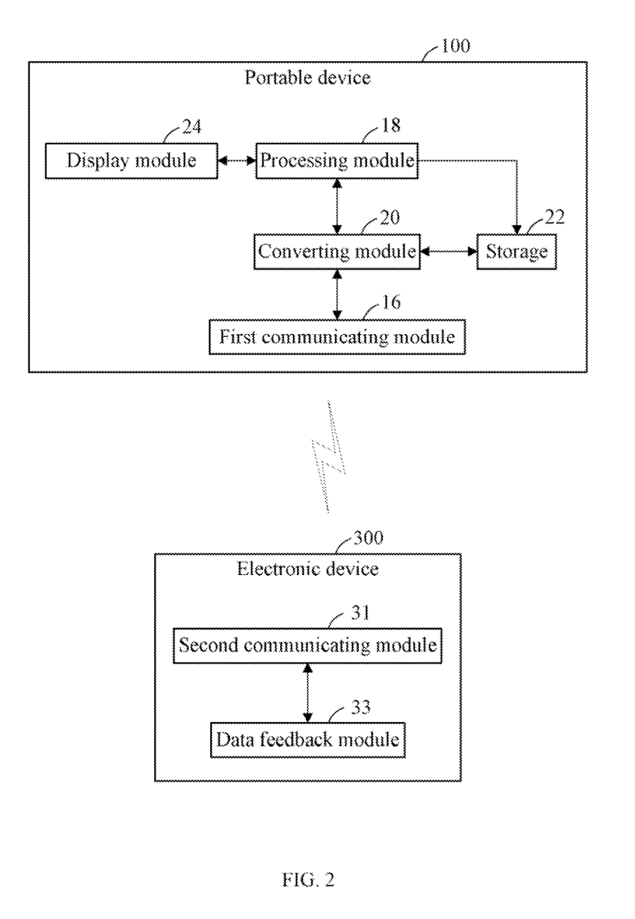

FIG. 2 shows a block diagram of the portable device 100 of the embodiment. The portable device 100 includes a first communicating module 16, a processing module 18, a converting module 20, storage 22, and a display module 24.

The first communicating module 16 establishes communication with the electronic device 300 in response to the operation of a user and intercommunicates data in the second format between the portable device 100 and the electronic device 300.

The processing module 18 generates instruction data in the first format based on the operation of a user.

The converting module 20 is connected between the first communicating module 16 and the processing module 18. The converting module 20 converts data between the first format and the second format which is suitable for digital intercommunication between portable device 100 and the electronic device 300. When receiving instruction data (i.e., debugging data, testing data, and editing data) from the processing module 18, the converting module 20 converts the instruction data from the first format to the second format to output to the first communicating module 16. When receiving feedback data (i.e., debugging parameters, testing parameters, and feature parameters) from the first communicating module 16, the converting module 20 converts the feedback data from the second format to the first format to output to the processing module 18.

The processing module 18 further processes feedback data in the first format converted by the converting module 20.

The storage 22 stores a number of standard parameters and stores the feedback data, converted by the converting module 20, in the first mode.

The display module 24 displays the processed feedback data in the first format from the processing module 18.

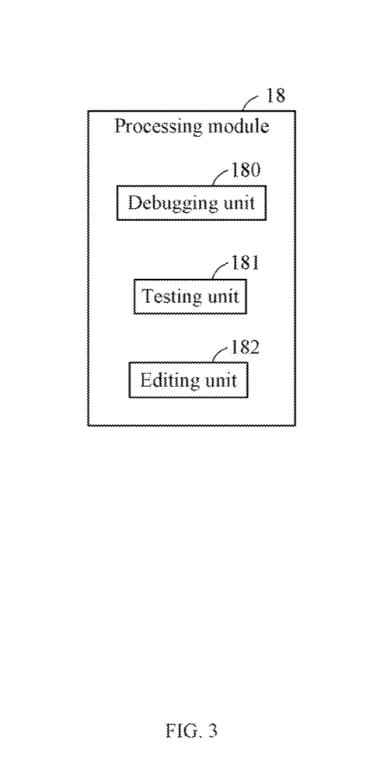

FIG. 3 shows the processing module 18 of the embodiment. The processing module 18 includes a debugging unit 180, a testing unit 181, and an editing unit 182.

The debugging unit 180 generates debugging data in the first format and sends it to the converting module 20 in response to the operation of a user. The debugging unit 180 further obtains the standard parameters in the first format from the storage 22 and simultaneously outputs the debugging parameters and the standard parameters in the first format to the display module 24 when received the debugging parameters in the first format from the converting module 20. A user can analyze errors by comparing the standard parameters and the debugging parameters.

The testing unit 181 generates testing data in the first format and sends it to the converting module 20 in response to the operation of a user. The testing unit 181 further analyzes the testing parameters in the first format to obtain function parameters in the first format and outputs the function parameters in the first format to the display module 24 when received the testing parameters in the first format from the converting module 20.

The editing unit 182 generates editing data in the first format and sends it to the converting module 20 in response to the operation of a user. The editing unit 182 further outputs the feature parameters in the first format to the display module 24 when receiving the feature parameters in the first format from the converting module 20. In the embodiment, the feature parameters include names and editions of processes in the electronic device 300, for example; the editing unit 182 controls the electronic device 300 to load new process, update the current process, or edit the current process.

The electronic device 300 includes a second communicating module 31 (see FIG. 2) and a data feedback module 33. The second communicating module 31 establishes a communication with the electronic device 300 according to the operation of a user.

The data feedback module 33 executes the received instruction data in the second format from the second communicating module 31 and generates corresponding feedback data in the second format.

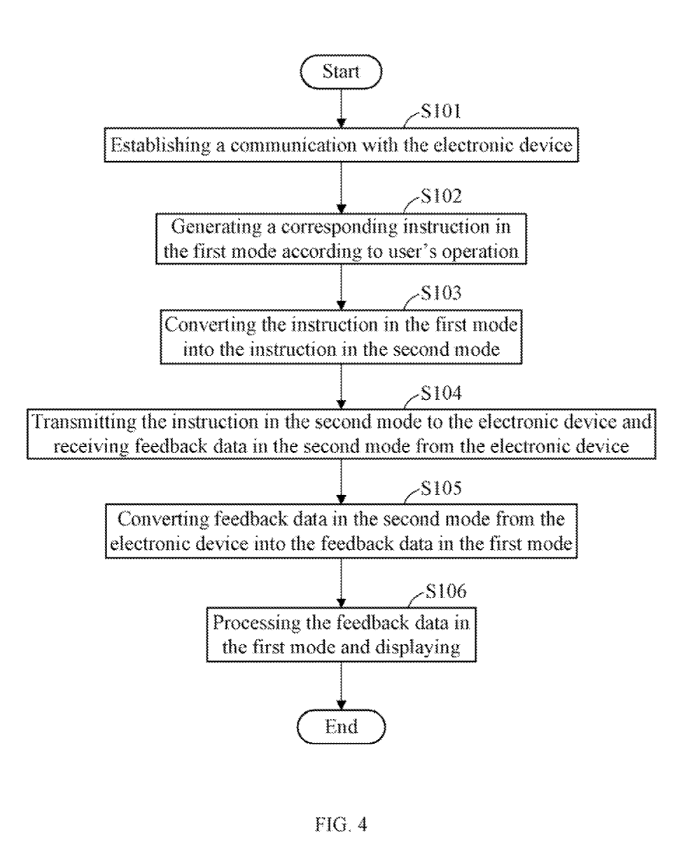

FIG. 4 shows that a signal converting method for converting instruction data generated by a portable device 100 from a first format to a second format for controlling an electronic device 300 to execute different functions. The portable device 100 stores a number of standard parameters. The testing method includes the following steps.

In step S101, the first communicating module 16 establishes a communication with the electronic device 300.

In step S102, the processing module 18 generates a corresponding instruction data in the first format according to the operation of a user. In the embodiment, the instruction data can be debugging data, testing data, or editing data, for example.

In step S103, the converting module 20 converts the instruction data from the processing module 18 from the first format to the second format.

In step S104, the first communicating module 16 transmits the instruction data in the second format to the electronic device 300 and receives feedback data in the second format from the electronic device 300. The feedback data in the second format is generated after the electronic device 300 executes the received instruction data in the second format. In the embodiment, the feedback data can be debugging parameters, testing parameters, and feature parameters, for example.

In step S105, the converting module 20 converts the feedback data from the second format to the first format.

In step S106, the processing module 18 processes the feedback data in the first format and controls the display module 24 to display the processed feedback data in the first format. When receiving the debugging parameters, the processing module 18 obtains the standard parameters and simultaneously outputs the debugging parameters and the standard parameters in the first format to the display module 24 for displaying. When receiving the testing parameters, the processing module 18 analyzes the testing parameters in the first format to obtain function parameters in the first format and outputs the function parameters to the display module 24 for displaying. When receiving feature parameters, the processing module 18 directly outputs the features parameters to the display module 24 for displaying.

In use, the portable device 100 generates instruction data to control the electronic device 300 and receives the feedback data from the electronic device 300 which is generated based on the received instruction, such that the portable device 100 can test and analyze error reasons of the electronic device 300.

While various embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A portable device capable of communicating with an electronic device, the portable device comprising:
a first communicating module capable of establishing a communication with the electronic device and intercommunicate data between the portable device and the electronic device;
a processing module capable of generating instruction data in a first format according to the operation of a user; and
a converting module connected between the first communicating module and the processing module;
wherein when the processing module generates the instruction data in a first format, the converting module converts the instruction data from the first format to the second format, and the communicating module sends the instruction data in the second format from the converting module to the electronic device, so as to control the electronic device to generate feedback data which is in the second format; the communicating module further receives feedback data in the second format from the electronic device, the converting module further converts the feedback data from the second format to the first format which can be processed by the processing module.

2. The portable device of claim 1, further comprising a storage and a display module, wherein the storage stores the feedback data, the processing module further processes the feedback data, and the display module displays the processed feedback data in the first format to users.

3. The portable device of claim 2, wherein the storage further stores a plurality of standard parameters; the processing module comprises a debugging unit; the instruction data comprises debugging data, and the feedback data comprises debugging parameters; when the debugging unit generates debugging data in the first format and sends it to the converting module, the converting module converts debugging data from the first format to the second format and the first communicating module transmits the converted debugging data in the second format to the electronic device and receives debugging parameters in the second format from the electronic device which are generated after executing the debugging data, the converting module further converts the debugging parameters from the second format to the first format, the processing module obtains standard parameters from the storage and simultaneously outputs the standard parameters and the converted debugging parameters to the display for displaying.

4. The portable device of claim 2, wherein the processing module comprises a testing unit; the instruction data comprises testing data and the feedback data comprises testing parameters; when the testing unit generates testing data in the first format and sends it to the converting module, the converting module converts testing data from the first format to the second format, the first communicating module transmits the converted testing data in the second format to the electronic device and receives testing parameters in the second format from the electronic device which are generated after executing the converted testing data, the converting module further converts the testing parameters from the second format to the first format, the processing module analyzes the converted testing parameters to obtain function parameters and outputs the function parameters to the display for displaying.

5. The portable device of claim 2, wherein the processing module comprises an editing unit; the instruction data comprises testing data and the feedback data comprises testing parameters; when the editing unit generates editing data in the first format and sends it to the converting module, the converting module converts editing data from first format to the second format, the first communicating module transmits the converted editing instruction data in the second format to the electronic device and receives feature parameters in the second format from the electronic device which are generated after executing the converted editing instruction data, the converting module further converts the feature parameters from the second format to the first format, the processing module directly outputs the converted function parameters to the display for displaying.

6. The portable device of claim 5, wherein the editing unit controls the electronic device to load new processes, update current processes, or edit current processes.

7. The portable device of claim 6, wherein the feature parameters are names and editions of processes in the electronic device.

8. A signal converting method for a portable device to intercommunicate data with an electronic device, the signal converting method comprising:
establishing a communication channel between the portable device and the electronic device;
generating instruction data with a first format in the portable device according to the operation of a user;
converting instruction data from the first format to a second format in the portable device;
transmitting the instructions data with the second format to the electronic device
receiving feedback data in the second format from the electronic device which is generated after executing instruction data in the second format;
converting feedback data from the second format to the first format; and
processing the feedback data in the first format and displaying the processed feedback data.

9. The method of claim 8, wherein the portable device further stores a plurality of standard parameters; when the instruction data is debugging data, the feedback data are debugging parameters; the step of processing the feedback data in the first format and displaying further comprising:
obtaining standard parameters data; and
displaying the obtained standard parameters and the converted debugging parameters in the first format simultaneously.

10. The method of claim 8, wherein when the instruction data is testing data, the feedback data are testing parameters; the processing the feedback data in the first format and displaying further comprising:
analyzing testing parameters data in the first format to obtain function parameters; and
displaying the function parameters.

11. The method of claim 8, wherein when the instruction data is editing data, the feedback data are features parameters; the feature parameters are names and editions of processes in the electronic device.

12. The method of claim 11, wherein the editing data is used for loading new processes, updating current processes, or editing current processes.
